(19) United States
(12) Patent Application Publication
(10) Pub. No.: US 2024/0184619 A1
(43) Pub. Date: Jun. 6, 2024

(54) SEGREGATED FABRIC CONTROL PLANE

(71) Applicant: MELLANOX TECHNOLOGIES, LTD., Yokneam (IL)

(72) Inventors: Ortal Bashan, Tel-Aviv (IL); Zachi Binshtock, Hod-Hasharon (IL)

(21) Appl. No.: 18/073,662

(22) Filed: Dec. 2, 2022

(51) Int. Cl. G06F 9/48; G06F 9/50; H04L 49/253

(52) U.S. Cl. CPC G06F 9/4806; G06F 9/5027; H04L 49/253

(57) ABSTRACT

A networking device and system are described, among other things. An illustrative system is disclosed to include a first processor to perform compute tasks associated with an operation; and a second processor to perform control plane tasks associated with the operation. The control plane tasks performed by the second processor relieve the first processor from responsibilities of performing the control plane tasks associated with the operation.

### FIELD OF THE DISCLOSURE

The present disclosure is generally directed to networking systems, methods, and devices and, in particular, toward a control plane system for a fabric of graphics processing units.

### BACKGROUND

Artificial intelligence (AI) is increasingly becoming a necessary tool used by enterprises in an endless number of technology areas. Enterprises with minimal AI-related expertise rely on AI to drive scientific progress. For example, scientists may train and use an AI engine to perform simulations, data analytics, etc.

Useful AI systems require powerful computing systems out of reach of many enterprises. Today's enterprises need a computing infrastructure that provides performance, reliability, and scalability to deliver cutting-edge products and services. AI servers are provided to such enterprises in which a fabric of graphics processing units (GPUs) can be utilized to perform AI- and other-related tasks.

### BRIEF SUMMARY

Embodiments of the present disclosure aim to provide a segregated control plane for an AI-server. Example aspects of the present disclosure include a networking device, comprising: a first processor to perform compute tasks associated with an operation; and a second processor to perform control plane tasks associated with the operation, wherein the control plane performed by the second processor relieve the first processor from responsibilities of performing the control plane tasks associated with the operation. Example aspects also include a server, comprising: a first processor to perform compute tasks associated with an operation; and a second processor to perform control plane tasks associated with the operation, wherein the control plane tasks performed by the second processor relieve the first processor from responsibilities of performing the control plane tasks associated with the operation. Example aspects further include a computer-implemented method for enabling performance of control plane tasks for a first processor, the method comprising: performing, by a first processor, compute tasks associated with an operation; and performing, by a second processor, control plane tasks associated with the operation, wherein the control plane tasks performed by the second processor relieve the first processor from responsibilities of performing the control plane tasks associated with the operation.

Any of the above example aspects include wherein the first and second processors are in communication via an interface.

Any of the above example aspects include wherein the control plane tasks comprise one or more of a subnet management function and a software defined network.

Any of the above example aspects include wherein the second processor coordinates aspects associated with a fabric of GPUs performing a task for the first processor.

Any of the above example aspects include wherein the first processor comprises a CPU connected to a fabric via an interface.

Any of the above example aspects include wherein the second processor comprises a data processing unit (DPU), the DPU comprising a processor and a network interface card.

Any of the above example aspects include wherein the DPU receives configuration setting data from a user.

Any of the above example aspects include wherein the second processor adjusts execution of one or more of drivers, fabric management, link training, port ID assignment, port management, and routing in response to configuration setting data received from a user.

Any of the above example aspects include wherein the second processor is in communication with a fabric via one or more of InfiniBand, NVLink and/or Ethernet interfaces.

Any of the above example aspects include wherein the fabric executes an artificial intelligence engine.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

The present disclosure is described in conjunction with the appended figures, which are not necessarily drawn to scale:

FIG. 1 illustrates a block diagram of a network topology for a networking system according to at least one example embodiment of the present disclosure;

FIG. 2 illustrates a block diagram of a networking device according to at least one example embodiment of the present disclosure; and

FIG. 3 illustrates a block diagram of a networking device including software tools according to at least one example embodiment of the present disclosure.

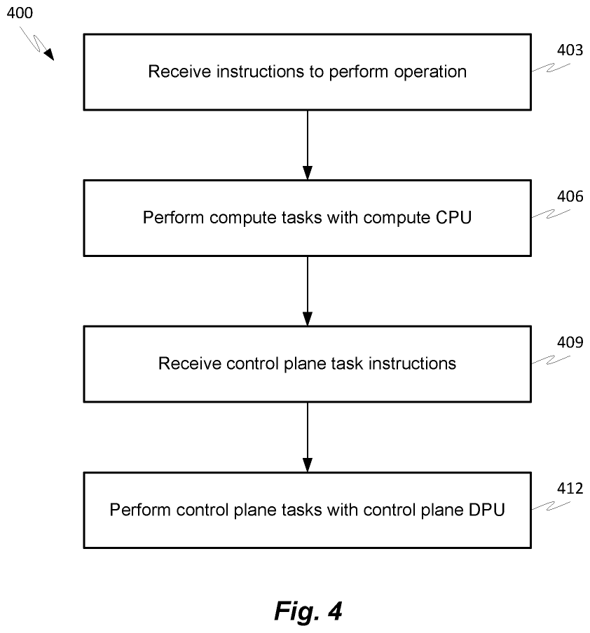

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

It will be appreciated from the following description, and for reasons of computational efficiency, that the components of the system can be arranged at any appropriate location within a distributed network of components without impacting the operation of the system.

Further, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a Printed Circuit Board (PCB), or the like.

The terms “determine,” “calculate,” and “compute,” and variations thereof, as used herein, are used interchangeably and include any appropriate type of methodology, process, operation, or technique.

Various aspects of the present disclosure will be described herein with reference to drawings that may be schematic illustrations of idealized configurations.

Networking devices such as routers, switches, Network Interface Controllers (NICs), etc. normally include a packet processing subsystem that manages the traversal of packets across a multi-layered network or protocol stack. For example, the network devices may be used in networking systems, like datacenters, for routing data between endpoints.

Some computing systems may comprise thousands of nodes and/or networking devices interconnected by a communication network. In some cases, the network devices may use distributed computing for processing packets and routing the corresponding data between endpoints. A distributed computing system may be defined as a system whose components are located on different networking devices, which communicate and coordinate actions by passing messages to one another.

The communications between the networking devices may include all-to-all communications, where each networking device sends individual messages to every other networking device in the distributed computing system. The all-to-all communications may include collective communications that use collective libraries (e.g., NVIDIA Collective Communications Library (NCCL), Unified Collective Communication (UCC), Message Passing Interface (MPI), etc.). For example, the collective libraries may be standardized and portable message-passing standards that are used for a variety of distributed computing environments and network topologies. Communications that use the collective libraries may occur within a group of processes, and collective communications may occur over all of the processes in the group.

A processing network may employ all-to-all communications for processing packets, routing data between endpoints, training models, etc. In some examples, the processing network may comprise a plurality of processes belonging to a collective (e.g., collective library, collective communications, etc.), and each process in the plurality of processes may send at least one message to every other process in the plurality of processes (e.g., all-to-all communications). The processing network may include or may be referred to as a network fabric. For example, a network fabric may comprise a number of meshed connections between a plurality of network devices (e.g., switches, routers, etc.), and the mesh of connections (e.g., network links) may be referred to as the network fabric. The network fabric may have inherent redundancy, as multiple switching resources are spread across a given data center, thus heling assure better application availability. Additionally, the network fabric may enable all-to-all communications and any-to-any connectivity (e.g., connectivity between any two network devices) with a predictable capacity and lower latency.

Researchers and data scientists are constantly in need of improved workflow and increased processing capabilities to execute research through the means of processing-heavy tasks such as AI deep learning and simulations. As a result, researchers, data scientists, and others rely upon complex computing elements such as servers and fabric-based computing elements. As described herein, a networking device contains a fabric of GPUs which work in tandem to serve the needs of researchers, data scientists, and others by performing complex computing tasks. Such a fabric presents the power of many GPUs to a user as a single device capable of performing complex tasks in a minimal amount of time. A networking device as described herein can be used by multiple users simultaneously.

In one or more of the embodiments, a networking device and/or computing device as described herein may comprise a server capable of performing tasks for users. Tasks may be, for example, AI-related tasks, such as training deep learning models, running simulations, etc. It should be appreciated a networking device as described herein may be utilized to perform any processing functions for users. The fabric of the networking device described herein may be capable of performing any number of different tasks for a wide range of users in a variety of technology areas, from medicine to physics and beyond.

The networking device may provide a networking fabric providing compute power for entities to offload processing-heavy tasks. The fabric as described below may provide model parallelism with high speeds, e.g., 2.4 terabytes per second (TB/s), of bisection bandwidth. When presented to a user, however, the user may interact with the fabric as one would interact with a single computing device, such as a single GPU. In this way, the networking device provides a simple tool capable of widespread use by an endless number of users.

Using a networking device as described herein, a user or entity may be enabled to build a private enterprise-grade AI cloud with virtualization support and an architecture for scaling. The networking device may be useful to enterprises to build AI models, run simulations, etc., by providing a high level of computing power without requiring complex setup performed by the user itself. As described herein, users of the networking device may be enabled to run compute tasks without being required to handle the management of the fabric itself. Such management may be referred to as control plane tasks.

Using a networking device as described herein, entities seeking to perform AI research or other processing-heavy computations may be enabled to access a GPU-based system capable of performing simulations and other tasks at high speeds. As described herein, this GPU-based system may be referred to as a fabric and may be useful for performing a great number of compute-heavy tasks. Because the control plane tasks are handled by a device other than the CPU used by the end-user, the networking device provides air-gapped security while maintaining ease of use.

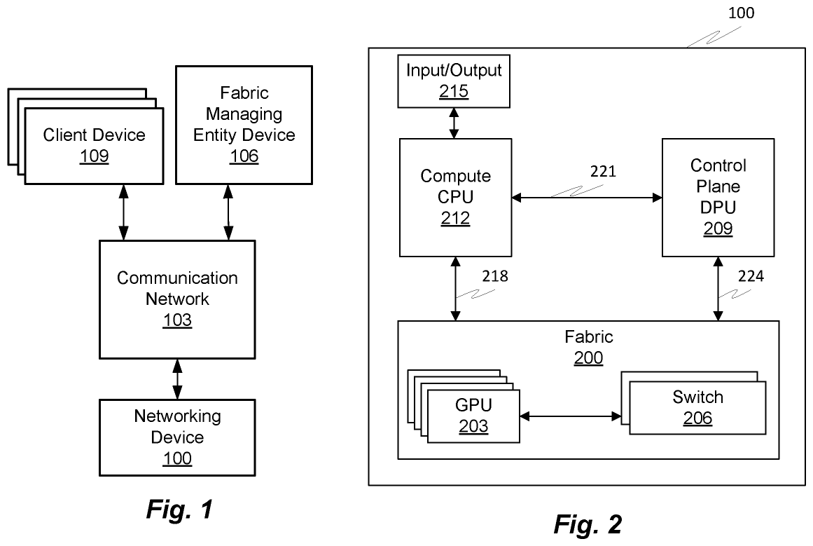

A networking device as described herein may be utilized as an AI supercomputer capable of offering data center technology without a data center and without additional IT investments. A networking device 100 may be as illustrated in FIG. 1. The networking device 100 may be capable of being used by multiple users simultaneously via client devices 109. Each client device 109 may be of a single entity or may client devices 109 of a number of different entities. The networking device 100 may be connected to a communication network 103 which may be network-connected and accessible to users anywhere in the world via the Internet in accordance with certain embodiments. Alternatively, or additionally, the networking device 100 as described herein may be offline and accessible via a local-area-network or otherwise available to local users only. Users instructing the fabric of the networking device 100 to perform computational tasks may interact with a compute CPU as described below.

Examples of the communication network 103 that may be used to connect the networking device 100 with the client devices 109 and/or the fabric managing entity device 106 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network 103 is a network that enables communication to and from the networking device 100 using Ethernet technology.

Although not explicitly shown in FIG. 1, the networking device 100 may include storage devices and/or processing circuitry for carrying out computing tasks, for example, tasks associated with controlling the flow of data within the networking device 100 and/or over the communication network 103. Such processing circuitry may comprise software, hardware, or a combination thereof. For example, the processing circuitry may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random-Access Memory (RAM), Read-Only Memory (ROM), variants thereof, combinations thereof, or the like. In some embodiments, the memory and processor may be integrated into a common device (e.g., a microprocessor may include integrated memory). Additionally, or alternatively, the processing circuitry may comprise hardware, such as an application specific integrated circuit (ASIC). Other non-limiting examples of the processing circuitry include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry may be provided on a PCB or collection of PCBs. It should be appreciated that any appropriate type of electrical component or collection of electrical components may be suitable for inclusion in the processing circuitry.

In addition, although not explicitly shown, it should be appreciated that the networking device 100 includes one or more communication interfaces for facilitating wired and/or wireless communication between one another and other unillustrated elements of the system.

### The Networking Device 100

Fabric management capabilities and processes may be controlled by a user using, for example, a fabric managing entity device 106 which may access the networking device 100 via the communication network 103. The fabric managing entity device 106 may be operated, for example, by a developer which provides the networking device 100 to entities. It should also be appreciated the fabric management may be controlled directly via interacting with the networking device 100. As described herein, fabric management may be controlled by a data processing unit (DPU) within the networking device 100. This DPU may be referred to as a control plane DPU as described below. Alternative to the functioning of conventional computing systems, the compute CPU of the networking device 100 may offload such management tasks to the control plane DPU as described in greater detail below. The fabric managing entity device 106 may interact with the control plane DPU via communicating with the compute CPU of the networking device 100 as described in greater detail below.

Conventional methods for offering fabrics of GPUs rely on client devices (CPUs) to manage the fabric. This creates downsides for the client in that the CPU is tasked both with both performing tasks for its own entity as well as for the fabric. Currently, clients are required to host management of the fabric out of its own software stack. These processing tasks can be substantial. Also, many client CPUs may not be capable of performing the necessary tasks relating to the control plane—what is needed is a dedicated DPU.

A client utilizing the networking device to perform tasks such as AI-related processes seeks to use the GPUs of the fabric as a resource. Such a client typically either lacks the skillset to manage the fabric or otherwise is not interested in adjusting the control plane of the fabric. Instead, the client's goal is typically to run processes using the fabric. The fact that the GPUs of the fabric are air-connected via a switch is typically unimportant to the client and important only to the entity providing the fabric as a service.

Using a networking device as described herein, the client sees only a GPU and needs not manage the fabric. The CPU used by the client to instruct the fabric, i.e., the compute CPU, is capable of offloading control plane tasks to the better-suited control plane DPU. As a result, the processing power of the compute CPU can be maximized towards the performance of utilizing the fabric to execute the processes required by the client.

Also, a fabric as described herein is powerful enough to be used by a plurality of separate entities, such as researchers from completely different groups or companies. As such, each entity may not want a competing entity to have control over the control plane tasks for the fabric. Keeping the control plane tasks away from the CPU used by the client devices provides greater security.

To achieve the segregation of the control plane from the compute plane, a DPU may be designated as a control plane DPU. The control plane DPU comprises a network interface card (NIC). The NIC of the control plane DPU may be used to communicate with the switch and the fabric, keeping the communication channel separate from the compute CPU.

The use of a DPU to perform the control plane tasks is further ideal for the execution of high-speed telemetry tools which are particularly demanding.

Because the control plane DPU is segregated from the compute CPU as described herein, business logic of the developer of the fabric can be kept separate from business logic of the client (i.e., the user of the fabric). The systems and methods described herein enable the entire control plane to be segregated from a customer's business logic. Everything involving the control plane, from global fabric management (GFM), tools, debuggability processes, etc., can be handled by the control plane DPU without consuming precious resources from the compute CPU.

Using a networking device as described herein, a switched server may be provided which is capable of being completely internal to an entity. Using a networking device as described herein, the entity may be enabled to directly control the fabric while avoiding the responsibility of managing the operation of the fabric.

The systems and methods described herein provide performance benefits for the compute CPU of the networking device, saving precious CPU cycles from what would otherwise be a very clogged CPU. For example, a CPU of a server is conventionally tasked with running NPI jobs, HPC jobs, etc., each of which have immense processing requirements. Using a system as described herein, the compute CPU of the networking device is not required to manage the control plane tasks, freeing up processing power for controlling the jobs being performed by the fabric.

A network device as described herein provides security in the form of air-gapping between compute plane and the control plane. The handles its own business logic while an entity in charge of handling the running of the fabric handles its own logic. Tasks relating to the job being performed by the fabric on behalf of a user are executed by the compute CPU and tasks relating to the performance of the fabric are run by the control plane DPU.

A networking device as described herein may in at least one embodiment comprise a fabric of GPUs interconnected with one or more switches, a compute CPU, and a control plane DPU. Each of these components are described in greater detail below.

### The Fabric 200

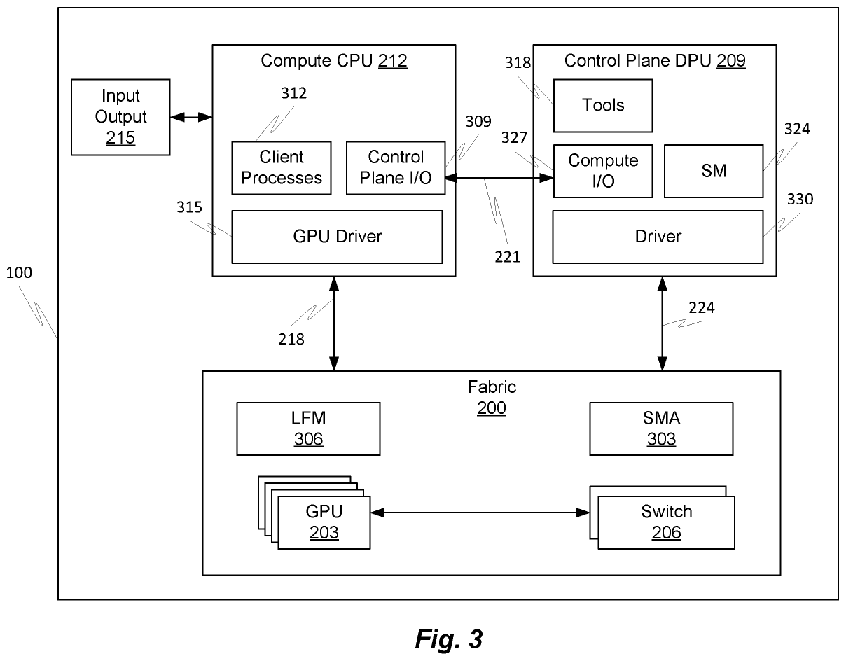

The networking device 100 may comprise a plurality of GPUs 203 interconnected with one or more switches 206. This interconnected group of GPUs 203 and switches form and operate as a fabric 200 as illustrated in FIG. 2. It should be appreciated the networking device 100 may contain any number of GPUs 203 and/or switches 206. As an example, the networking device may comprise sixteen or more GPUs 203 and, for example, twelve or more switches 206.

In some embodiments, the fabric 200 may be a software defined network (SDN), enabling dynamic, programmatically efficient connections between the GPUs 203 and switches 206 to implement the fabric 200 while improving fabric 200 performance and monitoring capabilities. As described herein, a control plane of the fabric 200 may be separate from the data plane or compute plane.

While the systems and methods described herein relate to the use of a plurality of GPUS 203, it should be appreciated that similar systems and methods may be used in relation to controlling a single GPU 203. Further, processing devices other than GPUs 203 may be used in certain embodiments. For example, systems and methods described herein may relate generally to the use of any number of CPUs, GPUs, DPUs, NICs, etc., to implement segregated compute and control planes.

The GPUs 203 of the networking device 100 may communicate with the one or more switches 206 via an NVLink connection such as NVL4. NVLink is a wire-based for near-range semiconductor communications that can be used for data and control code transfers in processor systems between GPUs 203 and/or other processing devices. NVLink specifies a point-to-point connection with data rates of, for example, 20, 25, 50 etc., Gigabit/s, per differential pair. Each GPU 203 may be capable of supporting, for example, up to 300 Gigabyte/s in total bi-directional bandwidth.

The GPUs 203 may be enabled to communicate via a direct GPU-to-GPU interconnect within the networking device 100. Further, each GPU 203 may communicate with one or more switches 206 via, for example, an NVLink connection.

The switches 206 of the networking device 100 may comprise, for example, NVSwitches. Each switch may enable direct communication with the GPUs and may feature, for example, a plurality of NVLink ports with non-blocking switching capacity of, for example, 3.2 terabytes per second (TB/s).

The fabric 200 may be managed from a centralized location as described herein. Control plane tasks associated with management of the functioning of the fabric 200 may be performed by the control plane DPU 212 of the networking device 100 as described herein. As described below, the control plane DPU 209 may communicate with the fabric 200 via an interface 224.

The fabric 200 may be used by an entity to execute compute-heavy processes such as an artificial intelligence engine. For example, a user of the networking device 100 may access the device 100 and use the fabric 200 of GPUs 203 as one would use a single GPU. The GPUs 203 may act as a fabric 200 to perform tasks requested by the user.

The fabric 200 may be capable of executing one or more firmware modules such as a subnet management agent (SMA) 303 and/or a local fabric manager (LFM). An SMA executed by the fabric may be capable of conversing with a subnet manager (SM) element executed by the control plane DPU 209. An LFM 306 may comprise an agent for a global fabric manager (GFM) and/or a user space process. In some embodiments, each GPU 203 of the fabric 200 may be associated with a distinct LFM 306.

The fabric 200 may receive compute instructions from a compute CPU 212 via interface 218. The fabric may receive control plane instructions from a control plane DPU 209 via interface 224 as described herein. Each of these interfaces 218, 224 are described in greater detail below.

### The Compute CPU 212

A compute CPU 212 as described herein may comprise one or more of a CPU, a GPU, a switch, a NIC, and a host channel adapter (HCA). The compute CPU 212 may be an Arm-based processor. While the systems described herein relate to a single CPU acting as a compute CPU 212, it should be appreciated the same or similar systems may be established utilizing two or more compute CPUs 212.

The compute CPU 212 may be tasked with interacting with the GPUs 203 on behalf of a user seeking to use the GPUs 203 to perform tasks. For example, instructing the fabric 200 to implement an AI model, run deep learning tasks, execute simulations, etc., may comprise interacting with the compute CPU 212 either directly via a user interface of the networking device 100 or remotely using one or more client devices 109.

The compute CPU may be controlled by one or more users to perform compute tasks associated with an operation. Compute tasks may comprise executing processes involving using the fabric 200 to perform tasks such as executing AI engines, models, simulations, etc. Such compute tasks may be referred to as client processes 309

In some embodiments, client devices 109 may communicate with the networking device 100 via a communication network 103 as illustrated in FIG. 1. The compute CPU 212 may communicate with such client devices 109 via input/output circuitry 215 of the networking device 100 as illustrated in FIG. 2. Such input/output circuitry 215 may comprise, for example, a NIC.

The compute CPU 212 may be enabled to provide multiple secure and confidential VMs, enabling a plurality of users to utilize the GPUs simultaneously. The networking device 100 may support single root input/output virtualization (SR-IOV) allowing for the sharing and virtualizing of a single PCIe-connected GPU 203 for multiple processes or VMs. For example, users on behalf of one or more entities using client devices 109 may each simultaneously interact with the compute CPU 212 to utilize the fabric 200 for performing tasks.

In some embodiments, partitioning can be managed from the compute CPU 212 while in other embodiments, partitioning may be performed by the control plane DPU 209. Partitioning may be used to partition the GPU into isolated, right-size instances to maximize quality of service (QOS) for smaller workloads. Such partitioning may be executed by either the compute CPU 212 or the control plane DPU 209 in accordance with certain embodiments.

The compute CPU 212 may execute one or more GPU drivers 315 which may enable the compute CPU 212 to perform client processes 312 and/or other functions using the fabric 200. For example, the compute CPU 212 may execute a GPU driver 315, CUDA toolkit, domain specific libraries, and/or other functions.

All control plane tasks can be offloaded from the compute CPU 212 to the control plane DPU 209 via an interface 221. This enables the compute CPU 212 to handle compute only and the control plane DPU 209 to handle control plane tasks only. The compute CPU 212 may execute I/O functions to and from the control plane DPU 209 via an input/output system 309 capable of communicating via interface 221. The interface 221 is described in greater detail below.

The compute CPU 212 may communicate with one or more client devices 109 and/or fabric managing entity devices 106 via a communication network 103 such as illustrated in FIG. 1. Such communication may be performed using one or more input/output circuits 215 as illustrated in FIG. 2 and as described in greater detail below.

The compute CPU 212 may communicate with the fabric 200 via an interface 218 as illustrated in FIG. 2 and as described in greater detail below.

### The Control Plane DPU 212

A networking device 100 as described herein comprises a processor to control plane tasks for the fabric 200. A control plane DPU 209 comprises a data processing unit (DPU) comprising the processor to control the control plane tasks as well as a network interface card (NIC).

In some embodiments, the control plane DPU 209 as described herein may comprise one or more core processors. It should be appreciated a control plane DPU 209 as described herein may be replaced by a CPU in combination with a NIC. For example, a CPU and a NIC may be capable of performing control plane tasks as described herein.

The control plane DPU 209 may be on a common board with the compute CPU 212 or may be on a separate board within the networking device 100.

The control plane DPU 209 may be dedicated toward the management of the functioning of the fabric 200. While the completion of jobs such as AI-related processes, simulations, and other processor-heavy processes performed by the fabric 200 are controlled and overseen by the compute CPU 212 as described above, the control plane DPU 209 may handle tasks relating to the functioning of the fabric 200. The control plane DPU 209 is used to coordinate aspects associated with the fabric 200 which performs tasks for the compute CPU 212.

The control plane DPU 200 may be controlled by an entity separate from an entity controlling the compute CPU, such as a developer of the fabric 200. For example, a fabric managing entity device 106 may interact with the networking device 100 over a communication network 103. Such communication may take place via the compute CPU 212 passing data over the interface 221 between the compute CPU 212 and the control plane DPU 209 as described below. In this way, clients such as users of client devices 109 can control compute tasks via the compute CPU 212 without the compute CPU 212 being bogged down by the control plane tasks which are offloaded to the control plane DPU 209.

The control plane DPU 209 may execute one or more software processes to manage the fabric 200. The control plane DPU may be in charge of everything from discovery, such as topology discover for the fabric 200 by discovering, training, and assigning any links, switches 206, GPUs 203, and other components of the fabric 200, port identification (ID), adjustment of the execution of one or more drivers, adjusting routing, such as by configuring routing tables on one or more switches 206 of the fabric 200, link training, such as initializing links between components of the fabric 200, otherwise controlling port management, such as by configuring ports of switches 206 of the fabric 200, adjustment of configuration settings, performing fabric management, and other functions relating to making the 200 fabric function. Each of these functions may be based on data received from the compute CPU,

The control plane DPU 209 may also execute a subnet manager (SM). The SM may be one or more of an InfiniBand controller and an NVL5 SDN controller. The SM may be in charge of discovery, LID assignment, link training, etc.

The control plane DPU 209 may also host one or more drivers 330 and execute other tools 318 in addition to or instead of those discussed above. Drivers 300 may include, for example, a kernel driver which may perform low level hardware management in response to GFM requests.

Control plane tasks may be performed by the control plane DPU and may relieve the compute CPU from responsibilities of performing the control plane tasks associated with the operation performed by the fabric. Using a system as described herein, delegation of work during the deployment and/or programming of the control plane DPU 209 can be performed without the involvement of the compute CPU 212. For example, a user of a client device 109 and/or a fabric managing entity device 106 may be enabled to control configuration setting data remotely via a communication network 103. Using a system as described herein, an air-gap between the compute CPU 221 and the control plane DPU 209 may be achieved. No additional conversation in runtime between the compute CPU 221 and the DPU 209 may be required to coordinate data offload and/or delegation.

The control plane DPU 209 may comprise a number of interfaces 221, 224. For example, an interface 221 between the compute CPU 221 and the control plane DPU 209 may enable communication from the control plane DPU 209 to the compute CPU 212. Communication from the control plane DPU 209 to the compute CPU 212 may be controlled using compute I/O circuitry 327 in the control plane DPU 209 and control plane I/O circuitry 309 in the compute CPU 212.

An interface 224 between the control plane DPU 209 and the fabric 200 may enable the control plane DPU 209 to directly control components of the fabric 200 such as the switches 206 and GPUs 203. Each of these interfaces 221 and 224 are described in greater detail below.

Security may in some embodiments be provided for the control plane DPU by using In-Band InfiniBand. For example, the control plane DPU may execute a software stack which provides in-band and out-of-band monitoring solutions for reporting both switch and GPU errors and status information.

### Input/Output 215 and Interfaces 218, 221, 224

The networking device 100 may comprise a number of interfaces as illustrated in FIG. 2. For example, the networking device 100 may comprise input/output circuitry 215 acting as an interface between the compute CPU and an external system, an interface 218 between the compute CPU 212 and the fabric 200, an interface 224 between the control plane DPU 209 and the fabric 200, and an interface 221 between the compute CPU 221 and the control plane DPU 209

An input/output 215 system may act as an interface between the compute CPU and an external system. The input/output 215 may be one or more of Ethernet, InfiniBand, or another connection system.

The compute CPU 212 may be connected to the fabric 200 via an interface 218 such as an NVLink, PCIe, InfiniBand, or other connection system. Data transfers between the compute CPU 212 and the GPUs 203 may be encrypted/decrypted at, for example, PCIe line rate using a hardware implementation of AES256-GCM, providing both confidentiality and integrity for data transferred between the compute CPU 212 and the GPUs 203.

An interface 224 between the control plane DPU 209 and the fabric 200 may comprise, for example, an InfiniBand connection.

The compute CPU 212 may be configured to communicate with the control plane DPU 209 via an interface 221. The interface 221 may in some embodiments comprise a back-to-back Ethernet NIC connection utilizing provisioning. In some embodiments, one or more of an InfiniBand and an Ethernet interface may be used. The interface 221 may provide for back-to-back Ethernet NIC connectivity. Users of the compute CPU 212 and/or external devices such as the client device 109 and/or the fabric managing entity device 106 may be enabled to log-in to access elements of the control plane DPU 209. The interface 221 may enable such users to install software, modify software, reconfigure elements, adjust configuration settings, etc. Via the interface 221, the compute CPU 212 can perform like a software bridge or a jump-server toward the control plane DPU 209. Using the interface 221, NIC emulation can be generated and traffic can be redirected to the control plane DPU 209. In this way, only one external port is necessary, via input/output 215, to access both the compute CPU 212 and the control plane DPU 209. As should be appreciated, the networking device 100 retain security like firewalls and/or other security rules, while still providing air-gapping between the compute functions and the control of the fabric 200.

In some embodiments, a method 400 such as illustrated in FIG. 4 may be performed in accordance with one or more of the systems described herein. For example, a networking device 100 may be used by one or more users to instruct a compute CPU 212 to perform an operation using a fabric 200 such as an AI task while an entity such as a developer of the networking device 100 may instruct a control plane DPU 209 to perform control plane operations managing the functioning of the fabric 200.

The method 400 may begin at 403 with a compute CPU 212 receiving instructions from a user to perform a task or operation using a fabric 200. As described above, receiving instructions from a user may comprise receiving instructions over a communication network 103 or may comprise receiving instructions directly via input to the compute CPU 212. The instructions may be a request for an AI-related process or another compute-heavy to be performed by the fabric 200.

At 406, the compute CPU 212 may perform compute tasks associated with the task such as instructing the fabric 200 to perform one or more operations. Performing compute tasks associated with the task may comprise the compute CPU 212 communicating with the fabric 200 over the interface 218 as described above.

At 409, the compute CPU 212 may receive instructions relating to control plane tasks associated with the fabric 200. As described above, receiving instructions relating to control plane tasks may comprise receiving instructions over a communication network 103, for example from a fabric managing entity device 106, or may comprise receiving instructions directly via input to the compute CPU 212. The instructions may be a request to adjust configuration settings or other operation-related factors relating to the fabric 200.

At 412, the control plane DPU 209 may perform the control plane tasks by controlling the functioning of the fabric 200. Performing the control plane tasks may comprise communicating with the fabric 200 over the interface 224 as described above.

Any of the steps, functions, and operations discussed herein can be performed continuously and automatically.

The exemplary systems and methods of this disclosure have been described in relation to a dual connect switch module. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A networking device, comprising:
a first processor to perform compute tasks associated with an operation; and
a second processor to perform control plane tasks associated with the operation,
wherein the control plane tasks performed by the second processor relieve the first processor from responsibilities of performing the control plane tasks associated with the operation.

2. The networking device of claim 1, wherein the first and second processors are in communication via an interface.

3. The networking device of claim 1, wherein the control plane tasks comprise one or more of a subnet management function and a software defined network.

4. The networking device of claim 1, wherein the second processor coordinates aspects associated with a fabric of GPUs performing a task for the first processor.

5. The networking device of claim 1, wherein the first processor comprises a CPU connected to a fabric via an interface.

6. The networking device of claim 1, wherein the second processor comprises a data processing unit (DPU), the DPU comprising a processor and a network interface card.

7. The networking device of claim 6, wherein the DPU receives configuration setting data from a user.

8. The networking device of claim 1, wherein the second processor adjusts execution of one or more of drivers, fabric management, link training, port ID assignment, port management, and routing in response to configuration setting data received from a user.

9. The networking device of claim 1, wherein the second processor is in communication with a fabric via one or more of InfiniBand and Ethernet interfaces.

10. The networking device of claim 9, wherein the fabric executes an artificial intelligence engine.

11. A server, comprising:
a first processor to perform compute tasks associated with an operation; and
a second processor to perform control plane tasks associated with the operation,
wherein the control plane tasks performed by the second processor relieve the first processor from responsibilities of performing the control plane tasks associated with the operation.

12. The server of claim 11, wherein the second processor is in communication with a fabric via one or more of InfiniBand and Ethernet interfaces.

13. The server of claim 11, wherein the control plane tasks comprise one or more of a subnet management function, a software defined network, and a global fabric management function for a fabric.

14. The server of claim 11, wherein the second processor coordinates aspects associated with a fabric of GPUs performing a task for the first processor.

15. The server of claim 11, wherein the first processor comprises a CPU to a fabric via an interface.

16. The server of claim 11, wherein the second processor comprises a data processing unit (DPU), the DPU comprising a processor and a network interface card.

17. The server of claim 16, wherein the DPU receives configuration setting data from a user.

18. The server of claim 11, wherein the second processor adjusts execution of one or more of drivers, fabric management, link training, port ID assignment, port management, and routing in response to configuration setting data received from a user.

19. A computer-implemented method for enabling performance of control plane tasks for a first processor, the method comprising:
performing, by a first processor, compute tasks associated with an operation; and
performing, by a second processor, control plane tasks associated with the operation,
wherein the control plane tasks performed by the second processor relieve the first processor from responsibilities of performing the control plane tasks associated with the operation.

20. The method of claim 19, wherein the first and second processors are in communication via an interface.
